(19) United States
(12) Patent Application Publication
(10) Pub. No.: US 2024/0348733 A1
(43) Pub. Date: Oct. 17, 2024

(54) IMAGE READING APPARATUS

(71) Applicant: KYOCERA Document Solutions Inc., Osaka (JP)

(72) Inventor: Hitoshi ASAKA, Osaka (JP)

(73) Assignee: KYOCERA Document Solutions Inc., Osaka (JP)

(21) Appl. No.: 18/630,320

(22) Filed: Apr. 9, 2024

(30) Foreign Application Priority Data
Apr. 13, 2023 (JP) 2023-065741

(51) Int. Cl. H04N 1/00; H04N 1/047

(52) U.S. Cl. CPC H04N 1/00814; H04N 1/047

(57) ABSTRACT

A carriage includes an optical system that detects reflected light from an image reading position on a document. A carriage controller controls, when the image of the document is to be read, movement of the carriage through a drive device, on the basis of the position of the carriage with respect to a predetermined reference position. A carriage travel measurer performs measurement about the movement of the carriage, and generates a measurement value. A reset decider decides whether the position of the carriage recognized by the carriage controller has to be reset, on the basis of the measurement value. When it is decided that the position of the carriage has to be reset, the carriage controller detects the reference position, and resets the position of the carriage.

### INCORPORATION BY REFERENCE

This application claims priority to Japanese Patent Application No. 2023-065741 filed on Apr. 13, 2023, the entire contents of which are incorporated by reference herein.

### BACKGROUND

The present disclosure relates to an image reading apparatus.

Many of existing image reading apparatuses are configured to scan a document in the sub scanning direction, with a carriage including an optical system that detects reflected light from an image reading position on the document, and receive the reflected light with an image sensor, to thereby optically read the image of the document. In the image reading apparatus configured as above, the carriage is assumed to be set in position, when the carriage is detected to be located at a home position, regarded as the reference position. In the image reading apparatus, further, the travel distance of the carriage is measured, for example on the basis of pulse signals given to a motor for driving the carriage, and the current position of the carriage is detected, on the basis of the relative travel distance from the home position. However, the detected current position of the carriage may be shifted from the actual position of the carriage, owing to various factors. Accordingly, the position of the carriage to be detected is reset, by moving the carriage to the home position, to cancel such a positional shift of the carriage.

In addition, some image reading apparatuses are configured to identify, when the optical sensor located at a predetermined position has detected that a mirror unit (carriage) has passed, a shift between the recognized current position of the mirror unit and the predetermined position, and corrects the distance over which the mirror unit is to be moved, depending on the amount of the shift. Correcting thus the travel distance on the basis of the shift contributes to reducing the number of times that the mirror unit is moved to the home position to reset the current position.

### SUMMARY

The disclosure proposes further improvement of the foregoing techniques.

In an aspect, the disclosure provides an image reading apparatus including a carriage, a drive device, an image sensor, and a control device. The carriage includes an optical system that emits light to a document, and further reflects the light reflected by the document. The drive device moves the carriage along the document. The image sensor receives the reflected light from the optical system, and outputs a reading signal based on an image of the document. The control device includes a processor, and acts as an image acquirer, a carriage controller, a carriage travel measurer, and a reset decider, when the processor executes a control program. The image acquirer acquires the document image based on the reading signal. The carriage controller detects a position of the carriage with respect to a predetermined reference position, when reading the document image from the document, and controls a travel of the carriage, by activating the drive device on a basis of the detected position of the carriage. The carriage travel measurer measures the travel of the carriage, and detects a measurement value. The reset decider decides whether the position of the carriage detected by the carriage controller has to be reset, on a basis of the measurement value. The carriage controller resets the position of the carriage, when the reset decider decides that the position of the carriage has to be reset.

### BRIEF DESCRIPTION OF THE DRAWINGS

FIG. 1 is a schematic side view showing an internal configuration of an image reading apparatus according to an embodiment of the disclosure;

FIG. 2 is a block diagram showing an electrical configuration of the image reading apparatus according to the embodiment of the disclosure;

FIG. 3 is a flowchart for explaining an operation of the image reading apparatus according to Embodiment 1; and

FIG. 4 is a flowchart for explaining an operation of the image reading apparatus according to Embodiment 2.

### DETAILED DESCRIPTION

Hereafter, an image reading apparatus according to some embodiments of the disclosure will be described, with reference to the drawings.

### Embodiment 1

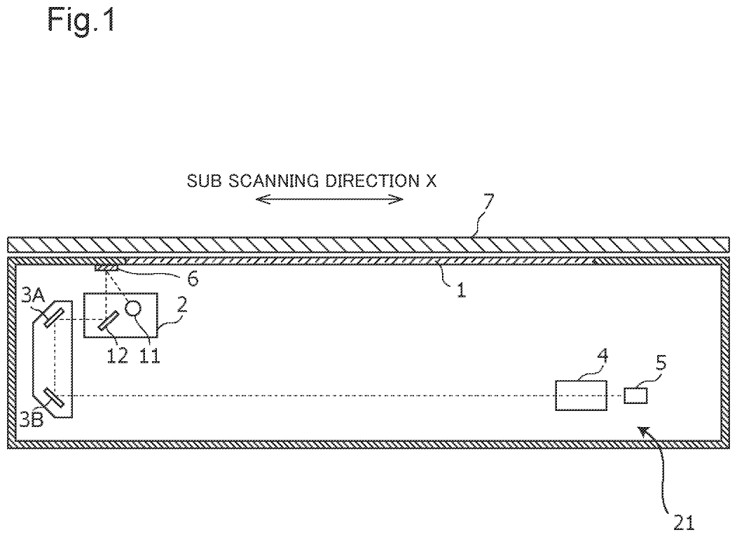

FIG. 1 is a schematic side view showing an internal configuration of the image reading apparatus according to the embodiment of the disclosure. The image reading apparatus shown in FIG. 1 is, for example, a scanner, a copier, a facsimile machine, or a multifunction peripheral.

The image reading apparatus shown in FIG. 1 includes an image reading device 21. The image reading device 21 includes a contact glass 1, a carriage 2, mirrors 3A and 3B, an imaging lens 4, an image sensor 5, a white reference plate 6, and a document cover 7.

The carriage 2 is installed so as to move in a sub scanning direction X (see FIG. 1), when driven by a drive device 21A to be subsequently described. The carriage 2 includes a light source 11 and a mirror 12. The light source 11 extends in a main scanning direction, orthogonal to the sub scanning direction X, and emits light, for example, from a plurality of LEDs aligned in the main scanning direction. In other words, the light source 11 emits light to a line extending along the main scanning direction. The light emitted from the light source 11 is reflected by a white reference plate 6, or a document placed on the contact glass 1, depending on the position of the carriage 2. The mirror 12 is a part of an optical system that reflects the light reflected by the white reference plate 6 or the document, thus emitting the light toward the mirror 3A. The mirrors 3A and 3B reflect the light from the mirror 12 in the carriage 2, thus emitting the light in the sub scanning direction X, toward the imaging lens 4 and the image sensor 5. The imaging lens 4 forms an image based on the light from the mirror 3B, in the image sensor 5.

As described above, the carriage 2 includes the optical system (light source 11 and mirror 12), configured to emit the light to the document, and further reflect the reflected light from the document.

The image sensor 5 receives the reflected light emitted from the carriage 2 through the optical system (mirrors 3A and 3B, and imaging lens 4 inclusive), and generates and outputs a reading signal based on the image of the document. The image sensor 5 is a linear sensor including light receiving elements respectively corresponding to a predetermined number of pixels aligned in the main scanning direction, and outputs, as the reading signal, electrical signals corresponding to the amount of light received by those pixels, with respect to each line. The image sensor 5 may be, for example, a charge coupled device (CCD).

The white reference plate 6 is attached to a ceiling portion of the inner space of the apparatus, so as to extend along the main scanning direction, to be used for acquiring reference data of white. The white reference plate 6 located at an end portion of the stroke range of the carriage 2, in the sub scanning direction.

In this embodiment, the position right under the white reference plate 6 is defined as the reference position (home position). A carriage controller 32 to be subsequently described (i) decides that the position of the carriage 2 accords with the reference position, when the read image based on the reading signal outputted from the image sensor 5 represents the image of the white reference plate 6 (predetermined white image). Alternatively, the carriage controller 32 (ii) decides that the position of the carriage 2 accords with the reference position, when a carriage detection signal indicating the position of the carriage, from an optical sensor located at a reference position (home position) in the image forming apparatus.

The document cover 7 is pivotably attached to the contact glass 1, so as to make surface contact therewith, and serves to keep the document in close contact with the contact glass 1, and prevent ambient light from intruding into inside of the apparatus through the contact glass 1, during the image reading operation.

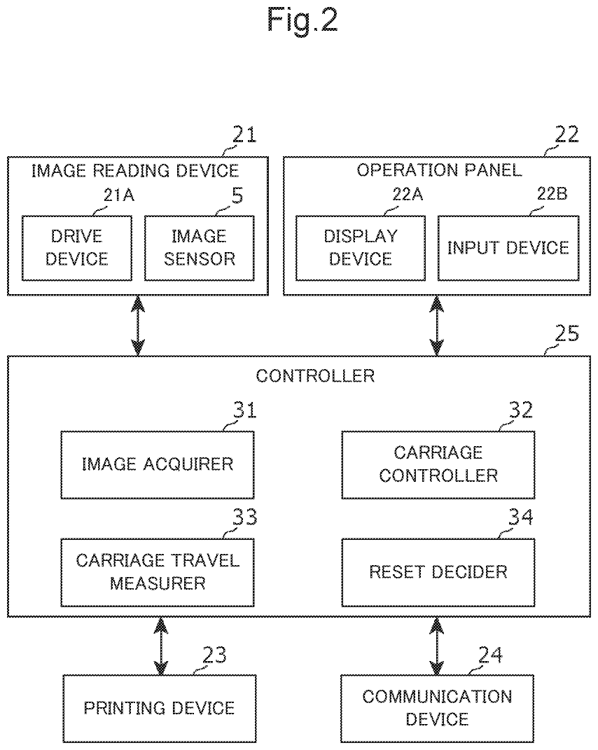

FIG. 2 is a block diagram showing an electrical configuration of the image reading apparatus according to the embodiment of the disclosure. The image reading apparatus shown in FIG. 1 and FIG. 2 includes, in addition to the image reading device 21, an operation panel 22, a printing device 23, a communication device 24, and a controller 25.

The image reading device 21 is an internal component configured as above, which optically reads the image of the document and generates the image data representing the document image. To be more specific, the image reading device 21 generates, under the control of the controller 25, the read image (document image) on the basis of the reading signal from the image sensor 5, transmitted from each position along the sub scanning direction X, while the drive device 21A is moving the carriage 2.

The drive device 21A that serves to move the carriage 2 includes, for example, a motor. The carriage 2 is moved by a belt driven by the motor, along the guide shaft extending along the sub scanning direction X.

The operation panel 22 is an internal component including a display device 22A such as an LCD, and an input device 22B such as a touch panel, and configured to display an operation screen for the user, and detect an inputting operation performed by the user.

The printing device 23 is an internal component, including an image forming mechanism that prints the document image on a printing sheet, for example through an electrophotographic process.

The communication device 24 is an internal component including, for example, a communication interface connectable to a non-illustrated host device or server via a network, and configured to perform data communication on the basis of a predetermined communication protocol.

The controller (exemplifying the control device in the disclosure) 25 includes a processor, a random-access memory (RAM), and a read-only memory (ROM). The processor is, for example, a central processing unit (CPU), an application specific integrated circuit (ASIC), or a micro processing unit (MPU). The controller 25 acts as an image acquirer 31, the carriage controller 32, a carriage travel measurer 33, and a reset decider 34, when the processor executes a control program stored in the ROM or a non-illustrated storage device.

The image acquirer 31 acquires a document image (image data such as RGB data), on the basis of the reading signal from the image sensor 5.

The carriage controller 32 measures the travel distance of the carriage 2, on the basis of pulse signals for controlling the action of the motor, acting as the drive device 21A, and detects the current position of the carriage, according to the relative travel distance from the home position. The carriage controller 32 detects the position of the carriage 2 with respect to a predetermined reference position, each time the image is read from the document, and drives the drive device 21A so as to move the carriage 2, according to the detected position of the carriage 2. To be more specific, the carriage controller 32 measures the relative distance from the predetermined reference position (home position), thereby detecting such relative distance as the position of the carriage 2, and retains as position data. The carriage controller 32 controls the movement of the carriage 2, on the assumption that the carriage 2 is located at the detected position. Here, the position of the carriage 2 detected by the carriage controller 32 may shift from the actual position of the carriage 2, owing to various factors.

The carriage travel measurer 33 performs measurement about the movement of the carriage 2, and detects a measurement value.

In Embodiment 1, the carriage travel measurer 33 counts the number of times that the carriage 2 has moved, and acquires the counted number of times of travel, as the measurement value.

The reset decider 34 decides whether the position of the carriage 2 recognized by the carriage controller 32 has to be reset, on the basis of the measurement value detected by the carriage travel measurer 33. When the reset decider 34 decides that the position of the carriage 2 has to be reset, the carriage controller 32 moves the carriage 2 to the reference position (home position), and resets the position of the carriage 2, detected when the carriage 2 is located at the reference position. In other words, the carriage controller 32 moves the carriage 2 to the reference position, upon deciding the position of the carriage 2 according to (i) or (ii) above, and resets, at this point, the value indicating the detected position of the carriage 2 (value indicating the relative distance from the reference position), to the initial value indicating the reference position.

The reset decider 34 decides whether the position of the carriage 2 detected by the carriage controller 32 has to be reset, on the basis of a comparison result between the measurement value and a predetermined threshold.

In this case, the carriage controller 32 does not perform the resetting operation, after each session of the reading operation of the document image, but continues with controlling the drive device 21A so as to move the carriage 2, on the basis of the detected position of the carriage 2. When the reset decider 34 decides that the position of the carriage 2 has to be reset, the carriage controller 32 controls the drive device 21A so as to move the carriage 2 to the reference position, thus performing the reset operation.

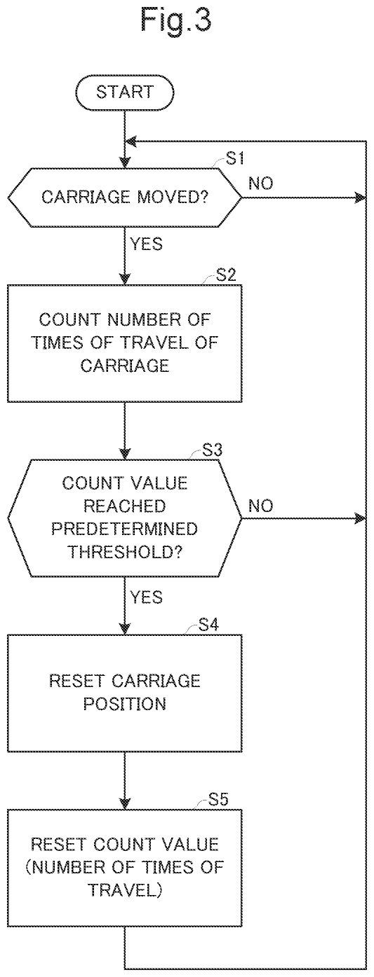

Hereunder, an operation of the image reading apparatus according to Embodiment 1 will be described. FIG. 3 is a flowchart for explaining the operation of the image reading apparatus according to Embodiment 1.

When the image reading operation is started, the carriage controller 32 causes the drive device 21A to move the carriage 2, on the basis of the current position of the carriage 2.

The carriage travel measurer 33 is monitoring whether the carriage 2 is moved (step S1), and adds 1 to the count value of the number of times of travel, when the carriage 2 is moved (step S2). Here, the initial value of the count value is zero. The term “travel of the carriage 2” refers, for example, to a series of movement of the carriage 2, from a predetermined reading start position in the sub scanning direction X, from which the carriage 2 starts to move in the sub scanning direction X to read the document, and back to the reading start position, after finishing the reading of the document.

Then the reset decider 34 decides whether the count value has reached the predetermined threshold (step S3). When the reset decider 34 decides that the count value has reached the predetermined threshold, the carriage controller 32 moves the carriage 2 to the reference position (home position), thereby performing the reset operation (step S4). When the current position of the carriage 2 is reset, the carriage travel measurer 33 resets the measurement value (number of times of travel) to zero (step S5). Here, the predetermined threshold refers to a value corresponding to a period (number of times of travel), about which it has been confirmed, for example through experiments performed in advance, that a shift is not incurred between the detected position of the carriage 2 and the actual position of the carriage.

In contrast, when the reset decider 34 decides that the count value has not reached the predetermined threshold, the operations of step S4 and step S5 are not performed. Instead, the operation returns to step S1, and the carriage travel measurer 33 continues with monitoring whether the carriage 2 is moved. Thus, the operations from step S2 are performed, each time the travel of the carriage 2 is detected.

According to Embodiment 1, as described above, the carriage 2 includes the optical system that detects the reflected light from the image reading position on the document. The image sensor 5 receives the reflected light, and outputs the reading signal based on the image of the document. The image acquirer 31 acquires the image of the document, according to the reading signal. The carriage controller 32 controls, when the image of the document is to be read, the movement of the carriage 2 through the drive device 21A, on the basis of the position of the carriage with respect to the predetermined reference position. The carriage travel measurer 33 performs measurement about the movement of the carriage 2, and generates the measurement value. The reset decider 34 decides whether the position of the carriage 2 detected by the carriage controller 32 has to be reset (whether the reset operation should be performed), on the basis of the measurement value. When it is decided that the position of the carriage 2 has to be reset, the carriage controller 32 moves the carriage 2 to the reference position, and resets the position of the carriage 2 that has been detected.

With the foregoing arrangement, the detection of the reference position is not performed each time the image reading operation is executed, and not performed until the condition related to the measurement value is established. Therefore, the number of times of execution of the reset operation can be reduced, without incurring an increase in cost, for example arising from providing additional sensors, and without compromise in detection accuracy of the position of the carriage 2. As result, a delay in the image reading operation can be suppressed, and the power consumption for executing the reset operation can be reduced.

### Embodiment 2

In Embodiment 2, the carriage travel measurer 33 identifies the travel distance each time the carriage 2 is moved, and detects the cumulative value of the travel distance (i.e., total travel distance after the position of the carriage 2 was reset), as the measurement value.

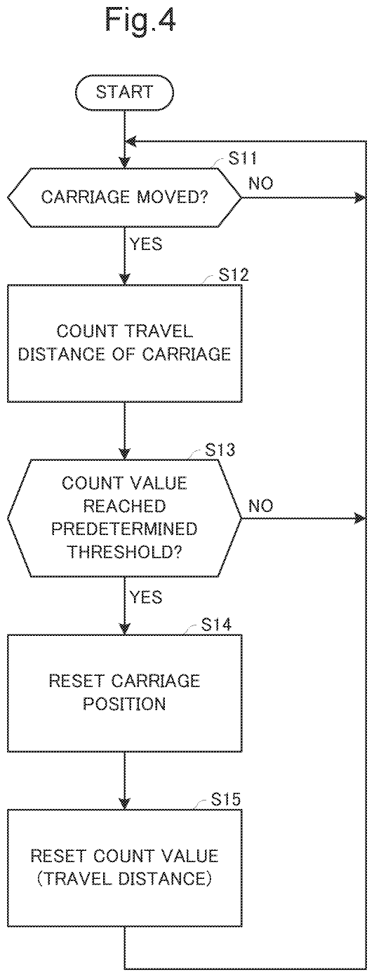

FIG. 4 is a flowchart for explaining an operation of the image reading apparatus according to Embodiment 2.

As in Embodiment 1, the carriage controller 32 moves the carriage 2 through the drive device 21A, on the basis of the current position of the carriage 2, when the image reading operation is to be performed.

The carriage travel measurer 33 is monitoring whether the carriage 2 is moved (step S11). In Embodiment 2, when the carriage 2 starts to move, the carriage travel measurer 33 detects the travel distance of the movement, for example on the basis of the pulse signal given to the motor acting as the drive device 21A, and increases the count value by an amount corresponding to the travel distance (step S12). The initial value of the count value is zero. Then the reset decider 34 decides whether the count value has reached a predetermined threshold (step S13). Here, the predetermined threshold refers to a value corresponding to a travel distance (cumulative value of the travel distance), about which it has been confirmed, for example through experiments performed in advance, that a shift is not incurred between the detected position of the carriage 2 and the actual position of the carriage.

When the reset decider 34 decides that the count value has reached the predetermined threshold, the carriage controller 32 moves the carriage 2 to the reference position, and resets the detected position of the carriage 2 (step S14). When the current position of the carriage 2 is reset, the carriage travel measurer 33 resets the measurement value (cumulative value of the travel distance) to zero (step S15).

In contrast, when the reset decider 34 decides that the count value has not reached the predetermined threshold, the operations of step S14 and step S15 are not performed. Instead, the operation returns to step S11, and the carriage travel measurer 33 continues with monitoring whether the carriage 2 is moved. Thus, the operations from step S12 are executed, each time the carriage 2 starts to move.

Other configurations and operations of the image reading apparatus according to Embodiment 2 are similar to those of Embodiment 1, and therefore the description thereof will not be repeated.

Various modifications and alterations to the foregoing embodiments are obvious to those skilled in the art. Such modifications and alterations may be made without departing from the scope and spirit of the subject, and without compromising the intended advantages. In other words, such modifications and alterations are encompassed in the scope of the appended claims.

For example, although the image sensor 5 is not provided on the carriage 2 in Embodiments 1 and 2, the image sensor 5 such as a contact image sensor (CIS) may be provided on the carriage 2.

Further, in Embodiments 1 and 2, the threshold may be adjusted by the carriage controller 32 itself, or by the carriage controller 32 according to an operation by the user or a service person, on the basis of the time elapsed from a predetermined reference time point, the number of times that the document image has been read, or the number of sheets of the documents read. For example, the threshold may be set to be lower, the longer the elapsed time becomes, or the more the number of times or the number of sheets becomes.

### INDUSTRIAL APPLICABILITY

The disclosure is applicable, for example, to image reading apparatuses such as a multifunction peripheral.

While the present disclosure has been described in detail with reference to the embodiments thereof, it would be apparent to those skilled in the art the various changes and modifications may be made therein within the scope defined by the appended claims.

What is claimed is:

1. An image reading apparatus comprising:
a carriage including an optical system that emits light to a document, and further reflects the light reflected by the document;
a drive device that moves the carriage along the document;
an image sensor that receives the reflected light from the optical system, and outputs a reading signal representing an image of the document; and
a control device including a processor, and configured to act, when the processor executes a control program, as:
an image acquirer that acquires the document image based on the reading signal;
a carriage controller that detects a position of the carriage with respect to a predetermined reference position, when reading the document image from the document, and controls a travel of the carriage, by activating the drive device on a basis of the detected position of the carriage;
a carriage travel measurer that measures the travel of the carriage, and detects a measurement value; and
a reset decider that decides whether the position of the carriage, detected by the carriage controller, has to be reset, on a basis of the measurement value,
wherein the carriage controller resets the position of the carriage, when the reset decider decides that the position of the carriage has to be reset.

2. The image reading apparatus according to claim 1,
wherein the carriage travel measurer measures the travel of the carriage, on a basis of a pulse signal for a motor acting as the drive device.

3. The image reading apparatus according to claim 1,
wherein the measurement value includes a number of times of the travel of the carriage.

4. The image reading apparatus according to claim 1,
wherein the measurement value includes a cumulative value of a travel distance of the carriage.

5. The image reading apparatus according to claim 1,
wherein, when the reset decider decides that the position of the carriage has to be reset, the carriage controller controls the drive device so as to move the carriage such that the detected position of the carriage accords with the reference position, after the document image has been read, and then resets the position of the carriage.

6. The image reading apparatus according to claim 1,
wherein the reset decider decides whether the position of the carriage detected by the carriage controller has to be reset, on a basis of a comparison result between the measurement value and a threshold, and
the threshold is set on a basis of a time elapsed from a predetermined reference time point, or a number of times that the document image has been read.
